(19) United States
(12) Patent Application Publication
(10) Pub. No.: US 2016/0057206 A1
(43) Pub. Date: Feb. 25, 2016

(54) APPLICATION PROFILE TO CONFIGURE AND MANAGE A SOFTWARE DEFINED ENVIRONMENT

(71) Applicant: International Business Machines Corporation, Armonk, NY (US)

(72) Inventors: Casimer M. DeCusatis, Poughkeepsie, NY (US); Vincenzo V. Di Luoffo, Sandy Hook, CT (US)

(21) Appl. No.: 14/462,672

(22) Filed: Aug. 19, 2014

(51) Int. Cl. H04L 29/08; H04L 29/06

(52) U.S. Cl. CPC H04L 67/10; H04L 67/303; H04L 67/42

(57) ABSTRACT

Systems and methods to manage a network include a memory storing an application profile and an application programming interface (API) configured to communicate with a plurality of network devices of a network. A processor may be configured to access the memory and to execute the application profile to concurrently configure multiple attributes of the plurality of network devices using the API.

### I. FIELD OF THE DISCLOSURE

The present disclosure relates generally to computer networking architectures, and in particular, to a system and a method for managing devices and communication flow in network.

### II. BACKGROUND

Servers, switches, memory, and other network devices are configured to perform an intended function, such as stock trading, credit card processing, or airline ticket booking. The network devices arrive shrink-wrapped with their own operating system and without security settings, programmed latencies, and routing protocols, among other network requirements. A user must manually and individually configure multiple network devices using different interfaces and according to the above requirements, in addition to bandwidth and other considerations. The resultant network is static and time consuming to reconfigure.

### III. SUMMARY OF THE DISCLOSURE

In a particular embodiment, an apparatus includes include a memory storing an application profile and an application programming interface (API) configured to communicate with a plurality of network devices of a network. A processor may be configured to access the memory and to execute the application profile to concurrently configure multiple attributes of the plurality of network devices using the API. According to another particular embodiment, a method of managing a network includes retrieving an application profile at a computing device in communication with a plurality of network devices, and executing the application profile to automatically and concurrently configure multiple attributes of the plurality of network devices using an API.

According to another particular embodiment, a computer readable medium stores instructions that, when executed by a processor, cause the processor to retrieve an application profile at a computing device in communication with a plurality of network devices, and to execute the application profile to automatically and concurrently configure multiple attributes of the plurality of network devices using an API.

An embodiment of an application profile enables a software defined environment to dynamically share attributes with different, subscribing devices to support an application in a secure manner. A centralized controller may be configured to communicate with all the resources, or devices, through appropriate APIs. Automated processes may replace weeks of manual labor to configure a network attribute. Features and other benefits that characterize embodiments are set forth in the claims annexed hereto and forming a further part hereof. However, for a better understanding of the embodiments, and of the advantages and objectives attained through their use, reference should be made to the Drawings and to the accompanying descriptive matter.

### IV. BRIEF DESCRIPTION OF THE DRAWINGS

FIG. 1 is a block diagram of a computing system configured to manage network configuration in a manner consistent with an embodiment;

FIG. 2 is a block diagram of the primary software components and resources of a computing system of FIG. 1;

FIG. 3 is a flowchart of an embodiment of a method of automatically and dynamically configuring and maintaining devices of a network; and

FIG. 4 is a flowchart of an embodiment of a method of configuring a network device with a firewall policy.

### V. DETAILED DESCRIPTION

An embodiment of a system to manage a network includes a single interface configured to concurrently program multiple network devices. For example, a programmer may interact and configured multiple switches and routers at once. Application profiles are written that allow end-to-end programming across switches and routers and storage. An imported application profile coordinates the network and storage components at one time in a software defined environment (SDE). An application profile may enable an SDE to dynamically share attributes with different, subscribing devices to support an application in a secure manner.

An SDE may include a data center where server networking and storage functionality is programmable. An SDE may include, for example, separate storage areas with common management to program the attributes of the storage. The SDE facilitates the initiation of application programming interfaces (APIs) that enable control over all of the network and storage components.

An embodiment of the application profile includes software used to implement registration services for new devices, public key authentication, and key management policies across network devices of an SDE. A user may dynamically select and apply an application profile that supports and manages the capabilities of a data center.

An embodiment of an application profile may drive SDE components to self-configure. The application profile may be published and subscribing (e.g., assigned or logically associated) devices import the attributes to configured. For instance, a firewall appliance may extend rules per specified attributes of an application profile.

Functions, such as firewall security, are typically implemented as hardware appliances distributed throughout a data center network. The application profile provides a security policy across network switches and other hardware devices of an SDE. The application profile may provide registration services, public key authentication, and key management policies, as well as other aspects of a trusted computing model.

Network devices may subscribe to an application profile to obtain application requirements. For example, a reverse proxy may assign security properties to a data traffic stream or to individual data packets. In another example, an application profile may manage a network firewall on a compute node, rather than as a separate physical appliance in the network. The firewall attribute of the application profile may categorize traffic into different virtual streams. For instance, streams of a network or compute node may be associated with a given application. Virtual streams may be associated with a different security domain depending on requirements to enforce firewall rules within a network.

Changes in a firewall policy may be implemented at a server in a single point of control, rather than on multiple distributed devices across the network. For example, a firewall policy adding new websites to a blacklist may be published to all subscribed devices. The attributes of the firewall policy may be published only to subscribed devices and do not allow attributes to be shared with devices unaffected by a policy. Authentication and key management for new switches and other devices joining a network may be referred to a centralized server implementing the application profile. Different application profiles may be loaded to different applications that may run in isolated virtual partitions on a common physical server.

The application profile may include program code residing on a server that is published to all of the devices in a network. The application profile may include one or more security policies and other attributes useful in network configuration. In an example, an application profile may include functions, or attributes, that include registration services used to facilitate including devices into a network. The application profile may include one or more of public key authentication for encryption, key refresh data, and key management policies so that a user imports the application profile into the SDE to initiate the automatic registration of the network devices.

In one example, a network function, or application, is directed to real-time stock market trading. The network function may require a specific number of virtual servers and may have a desired latency. Conventionally, a programmer would separately program each of the specified number of virtual or physical servers and then individually connect them to networks. The programmer would then have to analyze each one of those networks independently to select a network according to a particular task or performance criteria. Such conventional programming, evaluation, and selection processes are highly manual and time consuming. An embodiment capitalizes on functionality of an SDE to allow an imported application profile to concurrently program multiple network and storage components. In a software defined environment of an embodiment, the servers, networking, and storage may include programmable APIs that are slaved to, or controlled by, a common processor, or administrator.

In another example, a programmer may write an application profile for real-time stock trading. An application profile may be programmed to be executed by a controller configured to control an entire network topology. An attribute of the application profile may instruct the controller to determine a shortest latency path. The controller may determine the path automatically, realizing efficiency benefits over conventional manual approaches.

Once an application profile has been created, the application profile may be used with any other SDE. Application profiles of an embodiment may be published in a database accessible by multiple users. The users may receive and apply the application profile to an SDE of their choice. The applied application profiles may self-configure the network.

Continuing with the above example, a user may retrieve from storage and install a real-time stock trading application profile at the data center of their SDE. The imported application profile may automatically configure the whole data center according to the attributes of the stock trading profile.

An embodiment of an application profile is used to implement security features using network firewalls. The application profile may comprise software that includes network provisioning, as well as security functionality, such as authentication, and key management. The application profile may include virtual functions to communicate with the firewalls in the network. Firewalls are typically boxes with independent power supplies and memories that are mounted and cabled into an equipment rack. The firewall of an embodiment may include software, such as a virtual client, that may be executed in a virtual machine. In this manner, the firewall configuration may be included in the application profile.

A controller may execute the application profile to manage the firewall by categorizing traffic into different flows. The flows may travel from servers through the firewall down to storage and other resources. Each flow may be associated with a different kind of security policy or security domain. Where a user desires to make a software change to a firewall policy, the policy change may be made at the server using the application profile. The changed attributes of the application profile may be published to the firewall devices that are subscribed to the policy and that are running on the servers in the network. The changes to the attributes may be updated concurrently and automatically.

Because the changes may affect only those devices that are subscribed, concerns regarding an unlicensed party receiving an update are avoided. Similarly, the application profile may automatically authenticate and deliver public keys to a switch that is added to the network. Different profiles may be added for different applications, and applications may subscribe or unsubscribe to an application profile. Automated processes may replace weeks of manual labor to configure a network attribute.

An application profile of an embodiment may be executed to de-packet network traffic. For instance, the application profile may facilitate the recognition of types of arriving packets. The packets may be identified, for example, by their addresses and headers. The packets may be opened up so their contents can be examined. In one example, the firewalling function may dictate that all traffic coming from a certain address be let through, while traffic from another address is blocked. Recognition may prompt further treatment of different packets (e.g., on a per-packet basis). For example, certain types of packets may be de-packetized and inspected before being further routed. Another type of packet may be automatically identified as being a packet type that should be waitlisted without being de-packetized. A third packet may have an antivirus function run on it, per an application profile attribute.

Automated in an SDE, the application profile may include attributes of an application in a software script that runs on a server. A user may review multiple profiles available to import into a network. For example, application profiles relating to airline ticketing systems may be stored for download in a database. The user may select and install an application profile on a server. The application profile may take programmatic actions (e.g., programming the attributes) down through a cloud infrastructure and SDE of the network, including configuring the servers, the networking, and the storage. For instance, the application profile may set up the security and firewall policies according to an airline ticketing system.

Illustrative attributes of the application profile may specify a number of flows on the network, security requirements for applications and components, and instructions on packet inspection (e.g., a whitelist and a blacklist) Should a user be dissatisfied with the performance of an imported application profile, the user may retrieve and install another application profile relating to airline ticketing, for example. Alternatively, the user may customize an application profile on the fly, rather than swapping it out for another profile.

An SDE may include a management environment having APIs that go down to server, networking, and storage. The APIs can go to either physical or virtual devices. The APIs may facilitate management from a central controller, or a central administrator. The resources in the SDE may be separate, isolated management silos. In an embodiment of an SDE, there may be a centralized controller that is able to communicate with all the resources, or devices, through appropriate APIs.

In a particular example, an application profile may be used in an SDE that is open source, open air infrastructure, middleware for cloud computing. APIs defined by the SDE may be used by the application profile to communicate with servers, storage, and network. The SDE may have an API for servers and an API for networking. Another API may be directed to storage. An embodiment may exploit such a system having APIs down into the infrastructure. Another embodiment may use a vendor proprietary cloud stack.

An application profile of an embodiment may include software residing on a server or a virtual machine. The application profile may include a management policy for the network and for the network security. The application profile may publish that policy to any network device that is subscribed to it (e.g., using an SDE). The SDE may provide programmable interfaces down to the devices in the network from a central controller. Devices may subscribe to the application profile or may unsubscribe. The application profile may provide management and security services to the network. The application profile may additionally create flows through multiple switches and routers, end-to-end from one device to another. The application profile may implement virtual firewalls as waypoints on those flows.

In an example, a user may design a flow that begins at a first server and goes through three switches en route to a storage device. The user may place a virtual firewall between the server and a first hop into the network. The virtual firewall may include a security policy that specifies an authentication and public key, among other attributes. As such, an application profile may be used that programs the attributes into the appropriate virtual firewalls using the network APIs.

An SDE may provide an end-to-end view of a system to allow a service level agreement to be written. In addition to providing the end-to-end view, the SDE may support an application profile that automatically configures the system according to desired application attributes, such as network security.

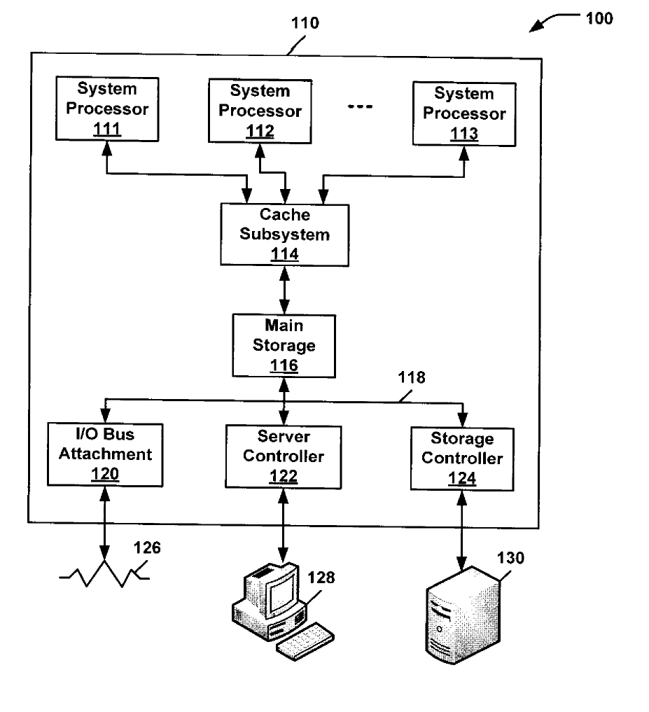

Turning more particularly to the drawings, FIG. 1 generally illustrates a data processing apparatus 100 that executes an application profile to automatically configure a system according to desired application attributes, such as network security. The apparatus 100, in specific embodiments, may include a computer network (e.g., a cloud computing environment or SDE), a computer system, a computing device, a server, a disk array, client computing entity, or other programmable device, such as a multi-user computer, a single-user computer, a handheld device, a networked device (including a computer in a cluster configuration), a mobile phone, a video game console (or other gaming system), etc. The apparatus 100 may be referred to as a logically partitioned computing system or computing system, but may be referred to as computer for the sake of brevity. One suitable implementation of the computer 110 may be a multi-user computer, such as a computer available from International Business Machines Corporation (IBM).

The computer 110 generally includes one or more physical processors 111, 112, 113 coupled to a memory subsystem including a main storage 116. The main storage 116 may include one or more dual in-line memory modules (DIMMs). The DIMM may include an array of dynamic random-access memory (DRAM). Another or the same embodiment may a main storage having a static random access memory (SRAM), a flash memory, a hard disk drive, and/or another digital storage medium. The processors 111, 112, 113 may be multithreaded and/or may have multiple cores. A cache subsystem 114 is illustrated as interposed between the processors 111, 112, 113 and the main storage 116. The cache subsystem 114 typically includes one or more levels of data, instruction and/or combination caches, with certain caches either serving individual processors or multiple processors.

The main storage 116 may be coupled to a number of external input/output (I/O) devices via a system bus 118 and a plurality of interface devices, e.g., an I/O bus attachment interface 120, a server controller 122, and/or a storage controller 124 that respectively provide external access to one or more external networks 126, one or more workstations 128, and/or one or more storage devices such as a direct access storage device (DASD) 130. The system bus 118 may also be coupled to a user input (not shown) operable by a user of the computer 110 to enter data (i.e., the user input sources may include a mouse, a keyboard, etc.) and a display (not shown) operable to display data from the computer 110 (i.e., the display may be a CRT monitor, an LCD display panel, etc.). The computer 110 may also be configured as a member of a distributed computing environment and communicate with other members of that distributed computing environment through a network 126.

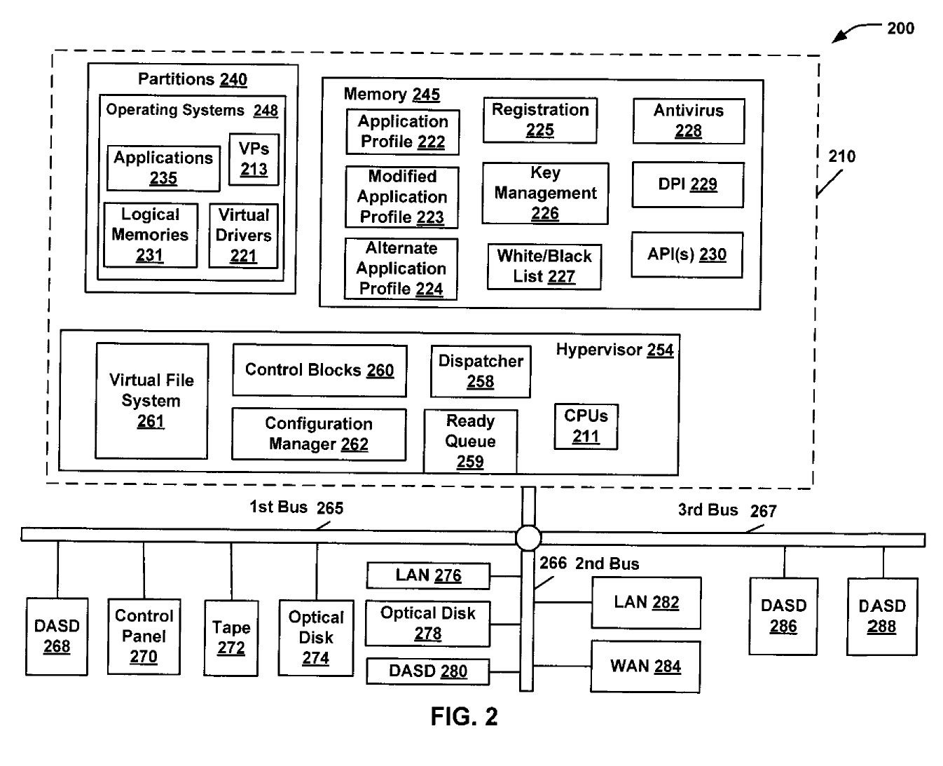

FIG. 2 illustrates in greater detail the primary software components and resources used to dynamically configure network devices in a cloud computing environment consistent with a particular embodiment. FIG. 2 generally shows a computing system 200 having a centralized computer 210 characterized as a virtual machine design, as developed by IBM. The computer 210 includes a plurality of partitions that share common processing resources. The logically partitioned computing system architecture may use a single computing machine having one or more processors 211, or central processing units (CPU), coupled with a system memory 245. The processors 211 may execute software configured to simulate one or more virtual processors (VPs) in one or more logical partitions 240.

The logical partitions 240 may each include a portion of the processors 211, the memory 245, and/or other resources of the computer 210. Each partition 240 typically hosts a respective operating environment, or operating system 248. After being configured with resources and the operating systems 248, each logical partition 240 generally operates as if it were a separate computer.

Virtual drivers 221 may interface with physical and virtual hardware to facilitate configuring network devices. For instance, the virtual drivers 221 may include network drivers, storage drivers and compute drivers to interface with server resources. One or more APIs 230 may be used to in conjunction with the virtual drivers 221 to automatically configure multiple network devices.

The memory 245 may include an application profile 222 that includes program code to automatically configure multiple network devices of an SDE. The configuration may align with system requirements. As such, illustrative configurable attributes of the application profile 222 may include a registration service authentication list 225, key management information 226, white list/black list information 227, antivirus programming 228, and deep packet inspection (DPI) 229, among other attributes corresponding to system configuration requirements.

The application profile 222 may be one of multiple application profiles that a user downloads to facilitate automatic configuration. As such, a user may retrieve an alternative application profile 224 and may modify another application profile 223 to customize attributes for a specific network application.

An underlying program, called a partition manager, a virtualization manager, or more commonly, a hypervisor 254, may be operable to assign and adjust resources to each partition 240. For instance, the hypervisor 254 may intercept requests for resources from the operating systems 248 or applications configured thereon in order to globally share and allocate the resources of computer 210. For example, when the partitions 240 within the computer 210 are sharing the processors 211, the hypervisor 254 may allocate physical processor cycles between the virtual processors 213 of the partitions 240 sharing the processors 211. The hypervisor 254 may also share other resources of the computer 210. Other resources of the computer 210 that may be shared include the memory 245, other components of the computer 210, other devices connected to the computer 210, and other devices in communication with computer 210. Although not shown, one having ordinary skill in the art will appreciate that the hypervisor 254 may include its own firmware and compatibility table. For purposes of this specification, a logical partition may use either or both the firmware of the partition 240, and hypervisor 254.

The hypervisor 254 may create, add, or adjust physical resources utilized by logical partitions 240 by adding or removing virtual resources from one or more of the logical partitions 240. For example, the hypervisor 254 controls the visibility of the physical processors 211 to each partition 240, aligning the visibility of the one or more virtual processors 213 to act as customized processors (i.e., the one or more virtual processors 213 may be configured with a different amount of resources than the physical processors 211. Similarly, the hypervisor 254 may create, add, or adjust other virtual resources that align the visibility of other physical resources of computer 210.

Each operating system 248 controls the primary operations of its respective logical partition 240 in a manner similar to the operating system of a non-partitioned computer. For example, each logical partition 240 may be a member of the same, or a different, distributed computing environment. As illustrated in FIG. 2, the operating system 248 may include an application 235. In one embodiment, the application 235 is a middleware application that connects applications, processes, and/or software components. In the illustrated embodiment, the application 235 may consist of a set of enabling services that allow multiple processes running on one or more logical partitions of one or more computers to interact. As such, the application 235 may be a distributed application configured across multiple logical partitions (i.e., as shown in FIG. 2, across logical partitions 240) of one or more computers (i.e., as shown in FIG. 2, application is configured across computer 210) as part of a distributed computing environment. One such distributed computing environment is a WebSphere architecture, as developed by IBM, such that a business may set up, operate, and integrate network-based websites, applications, or businesses across one or more computing systems.

Each operating system 248 may execute in a separate memory space, represented by logical memories 231. For example and as discussed herein, each logical partition 240 may share the processors 211 by sharing a percentage of processor resources as well as a portion of the available memory 245 for use in the logical memory 231. In this manner, the resources of a given processor 211 may be utilized by more than one logical partition 240. In similar manners, the other resources available to computer 210 may be utilized by more than one logical partition 240.

The hypervisor 254 may include a dispatcher 258 that manages the dispatching of virtual resources to physical resources on a dispatch list, or a ready queue 259. The ready queue 259 comprises memory that includes a list of virtual resources having work that is waiting to be dispatched to a resource of computer 210. As shown in FIG. 2, the hypervisor 254 includes processors 211 and processor control blocks 260. The processor control blocks 260 may interface with the ready queue 259 and comprise memory that includes a list of virtual processors 213 waiting for access on a respective processor 211. Although FIG. 2 illustrates at least one processor control block 260 for each processor 211, one skilled in the art will appreciate that the hypervisor 254 may be configured with more or less processor control blocks 260 than there are processors 211.

The computer 210 may be configured with a virtual file system 261 to display a representation of the allocation of physical resources to the logical partitions 240. The virtual file system 261 may include a plurality of file entries associated with respective portion of physical resources of the computer 210 disposed in at least one directory associated with at least one logical partition 240. As such, the virtual file system 261 may display the file entries in the respective directories in a manner that corresponds to the allocation of resources to the logical partitions 240. Moreover, the virtual file system 261 may include at least one virtual file entry associated with a respective virtual resource of at least one logical partition 240.

Advantageously, a user may interface with the virtual file system 261 to adjust the allocation of resources to the logical partitions 240 of the computer 210 by adjusting the allocation of the file entries among the directories of the virtual file system 261. As such, the computer 210 may include a configuration manager (CM) 262, such as a hardware management console, in communication with the virtual file system 261 and responsive to the interaction with the virtual file system 261 to allocate the physical resources of the computer 210. The configuration manager 262 may translate file system operations performed on the virtual file system 261 into partition management commands operable to be executed by the hypervisor 254 to adjust the allocation of resources of the computer 210.

Additional resources, e.g., mass storage, backup storage, user input, network connections, and the like, are typically allocated to the logical partitions 240 in a manner well known in the art. Resources may be allocated in a number of manners, e.g., on a bus-by-bus basis, or on a resource-by-resource basis, with multiple logical partitions 240 sharing resources on the same bus. Some resources may also be allocated to multiple logical partitions at a time. FIG. 2 illustrates, for example, three logical buses 265, 266, 267. The bus 265 is illustrated with a plurality of resources, including a DASD 268, a control panel 270, a tape drive 272, and an optical disk drive 274. All the resources may be allocated on a shared basis among logical partitions 240. Bus 266, on the other hand, may have resources allocated on a resource-by-resource basis, e.g., with a local area network (LAN) adapter 276, an optical disk drive 278, and a DASD 280 allocated to the logical partition 240, as to LAN and wide area network (WAN) adapters 282 and 284 allocated to the logical partition 242. The LAN and WAN adapters 282 and 284 interface with network devices of connected networks. The bus 267 may represent, for example, a bus allocated specifically to logical partition 244, such that all resources on the bus, e.g., DASDs 286, 288 are allocated to the same logical partition.

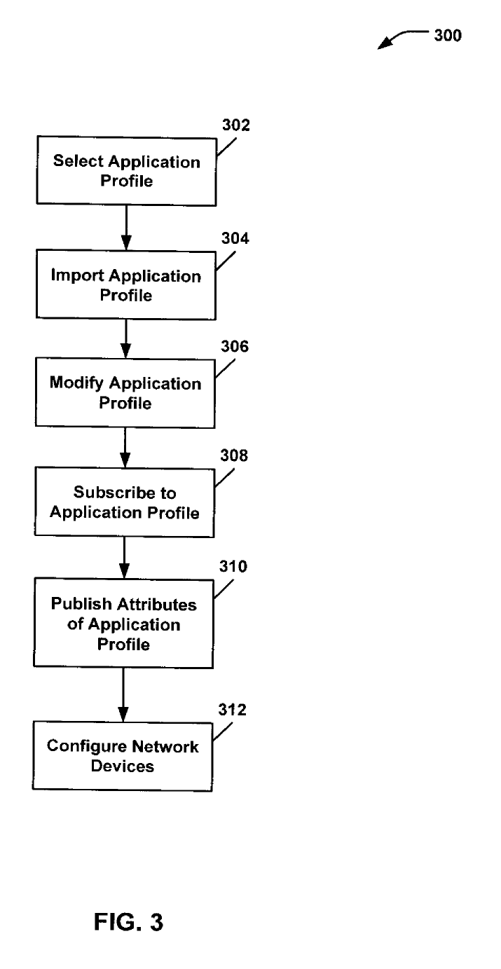

FIG. 3 is a flowchart of an embodiment of a method 300 of automatically configuring devices of a network using an application profile. The method 300 may be executed by an apparatus, such as the systems of FIGS. 1 and 2. Turning more particularly to the flowchart, a user may access a user interface of a central server to select an application profile at 302. As discussed herein, the application profile may be selected from a plurality of application profiles available for download. Different users may upload the plurality of application profiles to be stored in associated with an application or function, such as profiles for managing stock trading or booking airline tickets.

At 304, the selected application profile may be imported. For example, the central server computer of FIG. 2 may import the application profile 222. The application profile may be modified at 306. A user is able to customize the imported application profile to tailor attributes to specific network functions.

Network devices may be assigned or otherwise logically associated with the application profile at 308. In so doing, only subscribed network devices are automatically configured according to the attributes of the application profile. The attributes are published at 310 to all subscribing network devices. The network devices may be automatically and dynamically configured at 312.

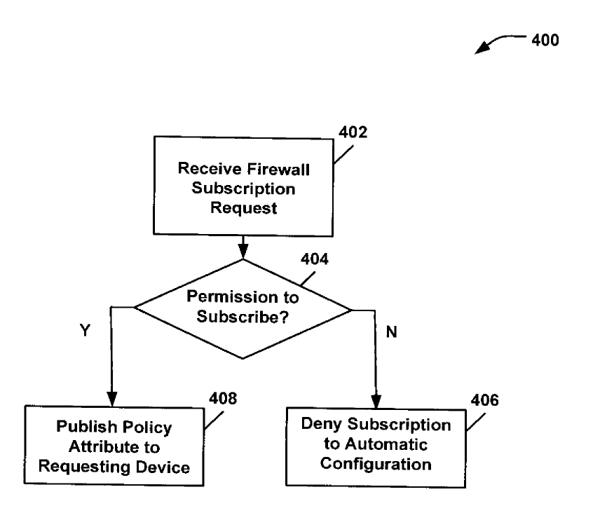

FIG. 4 is a flowchart of an embodiment of a method 400 to publish firewall policy attribute of an application profile to subscribing network devices. At 404 of the flowchart, a central server of an SDE may receive a firewall subscription request. A controller of the central server may determine at 404 if the requesting network device has permission to subscribe to the application profile. If not, the subscription request may be denied at 406. Where the requesting device alternatively has permission to subscribe to the application profile at 404, the firewall attribute may be published (e.g., by reverse proxy) at 408 to the requesting network device.

Particular embodiments described herein may take the form of an entirely hardware embodiment, an entirely software embodiment or an embodiment containing both hardware and software elements. In a particular embodiment, the disclosed methods are implemented in software that is embedded in processor readable storage medium and executed by a processor, which includes but is not limited to firmware, resident software, microcode, etc.

Further, embodiments of the present disclosure, such as the one or more embodiments may take the form of a computer program product accessible from a computer-usable or computer-readable storage medium providing program code for use by or in connection with a computer or any instruction execution system. For the purposes of this description, a non-transitory computer-usable or computer-readable storage medium may be any apparatus that may tangibly embody a computer program and that may contain, store, communicate, propagate, or transport the program for use by or in connection with the instruction execution system, apparatus, or device.

In various embodiments, the medium may include an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital versatile disk (DVD).

A data processing system suitable for storing and/or executing program code may include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) may be coupled to the data processing system either directly or through intervening I/O controllers. Network adapters may also be coupled to the data processing system to enable the data processing system to become coupled to other data processing systems or remote printers or storage devices through intervening private or public networks. Modems, cable modems, and Ethernet cards are just a few of the currently available types of network adapters.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and features as defined by the following claims.

1-9. (canceled)

10. A method of managing a network, the method comprising:
retrieving an application profile at a computing device in communication with a plurality of network devices; and
executing the application profile to automatically and concurrently configure multiple attributes of the plurality of network devices using an application programming interface (API).

11. The method of claim 10, further comprising receiving a subscription request from one of the plurality of network devices.

12. The method of claim 10, further comprising determining if one of the plurality of network devices is permitted to be configured using the application profile.

13. The method of claim 10, further comprising publishing an attribute to the plurality of network devices.

14. The method of claim 10, further comprising selecting the application profile from among a plurality of application profiles, wherein each of the plurality of application profiles is associated with an application.

15. The method of claim 10, further comprising modifying the application profile.

16. The method of claim 10, further comprising logically associating the application profile with the plurality of network devices.

17. The method of claim 10, further comprising publishing an attribute of the application profile to the plurality of network devices.

18. A computer readable medium storing instructions that, when executed by a processor, cause the processor to:
retrieve an application profile at a computing device in communication with a plurality of network devices; and
execute the application profile to automatically and concurrently configure multiple attributes of the plurality of network devices using an application programming interface (API).

19. The computer readable medium of claim 18, wherein the processor is further configured to retrieve the application profile from among a plurality of application profiles, wherein each of the plurality of application profiles is associated with an application.

20. The computer readable medium of claim 18, wherein the processor is further configured assign the application profile to the plurality of network devices.
